(19) United States
(12) Patent Application Publication
(10) Pub. No.: US 2006/0116304 A1
(43) Pub. Date: Jun. 1, 2006

(54) Detergent compositions

(75) Inventors: Allan Campbell McRitchie, Tyne and Wear (GB); Philip Frank Souter, Morpeth (GB); Jonathan Richard Clare, Newcastle upon Tyne (GB); Javier Medina, New Castle upon Tyne (GB); Zaiyou Liu, West Chester, OH (US); Neil Joseph Lant, New Castle upon Tyne (GB)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/287,659

(22) Filed: Nov. 28, 2005

Related U.S. Application Data
(60) Provisional application No. 60/724,758, filed on Oct. 7, 2005.

(30) Foreign Application Priority Data
Nov. 29, 2004 (EP) 04257384.0

(51) Int. Cl. C11D 3/50

(52) U.S. Cl. 510/101

(57) ABSTRACT

The present invention relates to perfume compositions that are especially useful for masking fatty acid odors, particularly short-chain fatty acid odors such as the odor of butyric acid, consumer products such as cleaning and/or treatment compositions comprising such perfume compositions, and processes of making and using such compositions and consumer products.

### CROSS-REFERENCES TO RELATED APPLICATIONS

This application claims priority under 35 U.S.C. § 119(e) to U.S. Provisional Application Ser. No. 60/724,758 filed Oct. 7, 2005.

### FIELD OF THE INVENTION

The present invention relates to perfume compositions that are useful for masking odors, cleaning and/or treatment compositions comprising such compositions, and processes of making and using same.

### BACKGROUND OF THE INVENTION

Consumers prefer that articles, such as garments, be as clean as possible. Such consumers typically associate the odor of a cleaned or treated article with the degree of cleanliness of such article. Thus, the effectiveness of a cleaning and/or treatment composition, from a consumer's perspective, is typically directly linked with the odor that such composition imparts to an article that is cleaned or treated with such composition. Applicants recognized that certain materials, such as esterases and lipases, can generate objectionable fatty acid odors, particularly short-chain fatty acid odors such as the odor of butyric acid. However, such materials can be particularly effective cleaning agents. Unfortunately, consumers typically associate the odors resulting from the use of such agents with a lack of cleanliness. Thus, there remains a need for a perfume composition that masks fatty acid odors, cleaning and/or treatment compositions comprising such compositions, and processes of making and using same.

### SUMMARY OF THE INVENTION

The present invention relates to perfume compositions that are useful for masking fatty acid odors, cleaning and/or treatment compositions comprising such compositions, and processes of making and using same.

### DETAILED DESCRIPTION OF THE INVENTION

Definitions

As used herein consumer products include articles and cleaning and treatment compositions.

As used herein, the term “cleaning and/or treatment composition” includes, unless otherwise indicated, tablet, granular or powder-form all-purpose or “heavy-duty” washing agents, especially laundry detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, laundry bars, mouthwashes, denture cleaners, car or carpet shampoos, bathroom cleaners; hair shampoos and hair-rinses; shower gels and foam baths and metal cleaners; as well as cleaning auxiliaries such as bleach additives and “stain-stick” or pre-treat types.

As used herein “Table 1 Perfume Components” means those perfume components listed in Table 1 which is found in this specification.

As used herein, the phrase “is independently selected from the group consisting of . . . ” means that moieties or elements that are selected from the referenced Markush group can be the same, can be different or any mixture of elements.

As used herein, the articles “a” and “an” when used in the specification or a claim, are understood to mean one or more of what is claimed or described.

The test methods disclosed in the Test Methods Section of the present application must be used to determine the respective values of the parameters of Applicants' inventions.

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited are, in relevant part, incorporated herein by reference; the citation of any document is not to be construed as an admission that it is prior art with respect to the present invention.

Perfume Compositions

The perfume compositions disclosed herein are especially useful for masking odors, particularly fatty acid odors, more particularly short-chain fatty acid odors such the odor of butyric acid, such perfume compositions are especially useful in detergent powders.

In one aspect of the invention said perfume composition comprises at least 10%, 20%, 30%, 40%, 50%, 60%, 70%, 80%, or even 90% of one or more perfume components having a molecular weight of greater than 0 but less than or equal to 350 daltons, from about 100 daltons to about 350 daltons, from about 130 daltons to about 270 daltons, or even from about 140 daltons to about 230 daltons; at least 80%, 85%, 90% or even 95% of said one or more perfume components having a cLogP of at least 2.4, from about 2.75 to about 8.0 or even from about 2.9 to about 6.0, said perfume composition comprising at least 5%, 15%, 25%, 35%, 45%, 55%, 65%, 75%, 85%, or even 95% of said one or more perfume components having a cLogP in the range of at least 2.4, from about 2.75 to about 8.0 or even from about 2.9 to about 6.0. In said aspect of the invention said one or more perfume components may be selected from the group consisting of a Schiff's base, ether, phenol, ketone, alcohol, ester, lactone, aldehyde, nitrile, natural oil or mixtures thereof. In certain aspects of the invention as recited above, said one or more perfume components may include Table 1 Perfume Components or even Table 1 Perfume Components 1 through 28.

In another aspect of the invention said perfume composition comprises at least 10%, 20%, 30%, 40%, 50%, 60%, 70%, 80%, or even 90% of a perfume component selected from the group consisting the components listed in Table 1 below and mixtures thereof.

TABLE 1

| | Chemical Name | CAS | Functionality | M Wt | clogP |
|---|---|---|---|---|---|
| 1 | 2-Methoxynaphthalene | 93-04-9 | Ether | 158 | 3.24 |
| 2 | Diphenyl ether | 101-84-8 | Ether | 170 | 4.24 |
| 3 | 2-methoxy-4-propenyl | 120-11-6 | Phenol | 164 | 4.63 |
| | phenol | | | | |
| 4 | 2-Methoxy-4 allyl phenol | 97-53-0 | Phenol | 164 | 2.40 |
| 5 | 4-Penten-1-one,1-(5,5- | 56973-85-4 | Ketone | 192 | 4.0 |
| | dimethyl-1-cyclohexen-1-yl) | | | | |
| 6 | (1alpha (E),2 beta)-1- | 71048-82-3 | Ketone | 192 | 3.62 |
| | (2,6,6-Trimethyl- | | | | |
| | cyclohex-3-en-1-yl)but-2- | | | | |
| | en-1-one | | | | |
| 7 | 3-Buten-2-one,3-Methyl-4- | 127-51-5 | Ketone | 206 | 4.0 |
| | (2,6,6-Trimethyl-2- | | | | |
| | Cyclohexen-1-yl) | | | | |
| 8 | 2-(2-(4-methyl-3- | 95962-14-4 | Ketone | 220 | 4.44 |
| | cyclohexen-1- | | | | |
| | yl)propyl)cyclopentanone | | | | |
| 9 | 4-[(2,6,6-trimethyl-1- | 127-41-3 | Ketone | 192 | 3.71 |
| | cyclohex-2-enyl)]but-3-en- | | | | |
| | 2-one | | | | |
| 10 | 1Buten-1-ol,2ethyl-4-(2,2,3-trimethyl-3- | 28219-61-6 | Alcohol | 208 | 4.43 |
| | cyclopentyl-1- | | | | |
| | yl)- | | | | |
| 11 | 2-Ethyl-4-(2,2,3- | 28219-61-6 | Alcohol | 208 | 4.43 |
| | trimethylcyclopent-3-enyl- | | | | |
| | 1)-2-buten-1-ol | | | | |
| 12 | Cyclopentaneacetic | 24851-98-7 | Ester | 226 | 2.42 |
| | acid,3oxo-2-pentyl-methyl | | | | |
| | ester | | | | |
| 13 | Methyl 2-hexyl-3-oxo- | 37172-53-5 | Ester | 226 | 3.09 |
| | cyclopentanecarboxylate | | | | |
| 14 | Tricyclodecenyl Propionate | 17511-60-3 | Ester | 206 | 2.89 |
| 15 | Tricyclo Decenyl Acetate | 2500-83-6 | Ester | 190 | 2.36 |
| 16 | n-pentyl salicylate | 2050-08-0 | Ester | 208 | 4.56 |
| 17 | chromen-2-one or 1,2- | 91-64-5 | Lactone | 146 | 1.41 |
| | benzopyrone | | | | |
| 18 | 4- | 30168-23-1 | Aldehyde | 204 | 3.63 |
| | (tricycle(5,2,1,0)decylidene- | | | | |
| | 8)butanal | | | | |
| 19 | 3-(3- | 125109-85-5 | Aldehyde | 190 | 3.55 |
| | isopropylphenyl)butanal | | | | |
| 20 | p-tert.Butyl-alpha- | 80-54-6 | Aldehyde | 204 | 3.86 |
| | methyldihydrocinnamic | | | | |
| | aldehyde | | | | |
| 21 | alpha-Hexylcinnamaldehyde | 101-86-0 | Aldehyde | 216 | 4.85 |
| 22 | n-octanal | 124-13-0 | Aldehyde | 128 | 2.95 |
| 23 | n-nonanal | 124-19-6 | Aldehyde | 142 | 3.98 |
| 24 | n-decanal | 10486-19-8 | Aldehyde | 156 | 5.60 |
| 25 | dodecanal | 112-54-9 | Aldehyde | 184 | 5.07 |
| 26 | Benzene propane nitrile | 97384-48-0 | Nitrile | 171 | 2.31 |
| | alpha-ethenyl-alpha-methyl | | | | |
| 27 | 2-cyclohexylidene-2- | 104621-98-0 | Nitrile | 197 | n/a |
| | phenylacetonitrile | | | | |
| 28 | Patchouli | n/a | Natural Oil | n/a | n/a |
| 29 | Naphtho[2,1-b]furan, | 3738-00-9 | Ether | 236 | 5.26 |
| | dodecahydro-3a,6,6,9a- | | | | |
| | tetramethyl- | | | | |
| 30 | Cyclopentanone,2-pentyl- | 4819-67-4 | Ketone | 154 | 2.94 |
| 31 | Ethanone,1-(1,2,3,4,5,6,7,8- | 54464-57-2 | Ketone | 234 | 4.84 |
| | octahydro-2,3,8,8- | | | | |
| | tetramethyl-2- | | | | |
| | naphthalenyl)- | | | | |
| 32 | 3-methyl-4(5)- | 82356-51-2 | Ketone | 236 | 5.60 |
| | cyclopentadecenone | | | | |
| 33 | 2(3H)-Furanone,5- | 104-67-6 | Lactone | 184 | 3.83 |
| | heptyldihydro- | | | | |
| 34 | Methyl ionone (mixture) | 1335-46-2 | Ketone | 206 | 4.23 |
| 35 | Spiro[1,3-dioxolane- | 154171-77-4 | Ketone | n/a | 5.67 |
| | 2,8′(5′H)-[2H- | | | | |
| | 2,4a]methanonaphthalene], | | | | |
| | hexahydro-1′,1′,5′,5′- | | | | |
| | tetramethyl-,[2′S- | | | | |
| | (2′.alpha.,4′a.alpha.,8′a.alpha.)]- | | | | |
| 36 | Undecanal,2-methyl- | 110-41-8 | Aldehyde | 184 | 4.85 |
| 37 | 10-Undecenal | 112-45-8 | Aldehyde | 168 | 4.05 |
| 38 | 4-Methyl-3-decen-5-ol | 81782-77-6 | Alcohol | 170 | |
| 39 | Benzoic acid,2-hydroxy-, | 25485-88-5 | Ester | 220 | 4.48 |
| | cyclohexyl ester | | | | |
| 40 | 4H-Inden-4-one,1,2,3,5,6,7- | 33704-61-9 | Ketone | 206 | 3.99 |
| | hexahydro-1,1,2,3,3- | | | | |
| | pentamethyl- | | | | |
| 41 | N-2,4-Dimethyl-3- | 68738-99-8 | Schiffs base | n/a | 4.78 |
| | cyclohexenemethylene | | | | |
| | methyl anthranilate | | | | |
| 42 | 2-Buten-1-ol,2-ethyl-4- | 28219-61-6 | Alcohol | 208 | 4.43 |
| | (2,2,3-trimethyl-3- | | | | |
| | cyclopenten-1-yl)- | | | | |
| 43 | Acetic acid,hexyl ester | 142-92-7 | Ester | 144 | 2.83 |
| 44 | 1,6-Octadien-3-ol,3,7- | 78-70-6 | Alcohol | 154 | 2.55 |
| | dimethyl- | | | | |
| 45 | Cyclohexanol,2-(1,1- | 88-41-5 | Ester | 198 | 4.06 |
| | dimethylethyl)-,acetate | | | | |
| 46 | 2-Butanone,4-(4- | 5471-51-2 | Ketone | 164 | 1.07 |
| | hydroxyphenyl)- | | | | |
| 47 | Ethanone,1-(2,3,4,7,8,8a- | 32388-55-9 | Ketone | 246 | 4.75 |
| | hexahydro-3,6,8,8- | | | | |
| | tetramethyl-1H-3a,7- | | | | |
| | methanoazulen-5-yl)-,[3R- | | | | |
| | (3.alpha.,3a.beta.,7.beta.,8a. | | | | |
| | alpha.)]- | | | | |
| 48 | Cyclododecane, | 58567-11-6 | Ether | 242 | 5.48 |
| | (ethoxymethoxy)- | | | | |
| 49 | Cyclohexane,3-ethoxy- | 24691-15-4 | Ether | 156 | 3.93 |
| | 1,1,5-trimethyl-,cis- | | | | |
| 50 | 1,3-Benzodioxole-5- | 120-57-0 | Ether/aldehyde | 150 | 1.14 |
| | carboxaldehyde | | | | |
| 51 | Benzoic acid,2-hydroxy-, | 118-58-1 | Ester | 228 | 4.22 |
| | phenylmethyl ester | | | | |
| 52 | 2-Cyclopenten-1-one,2- | 11050-62-7 | Ketone | 164 | 2.64 |
| | methyl-3-(2-pentenyl)- | | | | |
| 53 | Oxacyclohexadecen-2-one | 34902-57-3 | Lactone | 238 | 5.40 |
| 54 | 4-Cyclopentadecen-1-one, | 0014595- | Ketone | 222 | n/a |
| | (Z)- | 54-1 | | | |
| 55 | Benzoic acid,2-[(7- | 89-43-0 | Schiffs base | 305 | 4.17 |
| | hydroxy-3,7- | | | | |
| | dimethyloctylidene)amino]-, | | | | |
| | methyl | | | | |
| 56 | 4,7-Methano-3aH-indene- | 80623-07-0 | Ester | 209 | 3.37 |
| | 3a-carboxylic acid, | | | | |
| | octahydro-,ethyl ester, | | | | |
| | (3a.alpha.,4.beta.,7.beta.,7a. | | | | |
| | alpha.)- | | | | |
| 57 | Benzoic acid,2-hydroxy-,3- | 65405-77-8 | Ester | 220 | 4.61 |
| | hexenyl ester,(Z)- | | | | |
| 58 | Benzoic acid,2-amino-, | 134-20-3 | Ester | 151 | 2.02 |
| | methyl ester | | | | |
| 59 | Benzoic acid,2-hydroxy-, | 6259-76-3 | Ester | 222 | 5.09 |
| | hexyl ester | | | | |
| 60 | Carbonic acid,4-cycloocten- | 87731-18-8 | Ester | 184 | 2.77 |
| | 1-yl methyl ester | | | | |
| 61 | 5-Cyclohexadecen-1-one | 37609-25-9 | Ketone | 236 | 5.97 |
| 62 | Cyclohexanepropanoic acid, | 705-87-5 | Ester | 196 | 3.93 |
| | 2-propenyl ester | | | | |
| 63 | Pentanoic acid,2-methyl-, | 28959-02-6 | Ester | 144 | 2.61 |
| | ethyl ester,(S)- | | | | |
| 64 | 3-Buten-2-one,4-(2,6,6- | 79-77-6 | Ketone | 192 | 3.77 |
| | trimethyl-1-cyclohexen-1- | | | | |
| | yl)-,(E)- | | | | |
| 65 | 1,3-Dioxolane,2,4- | 131812-51-6 | Ether | 288 | 6.27 |
| | dimethyl-2-(5,6,7,8- | | | | |
| | tetrahydro-5,5,8,8- | | | | |
| | tetramethyl-2-naphthalenyl)-, | | | | |
| | cis- | | | | |
| 66 | 2,6-Octadienenitrile,3,7- | 5146-66-7 | Nitrile | 227 | 3.25 |
| | dimethyl- | | | | |
| 67 | 2,6-Nonadienenitrile,3,7- | 61792-11-8 | Nitrile | 163 | 3.78 |
| | dimethyl- | | | | |
| 68 | 3-Cyclohexene-1- | 27939-60-2 | Aldehyde | 138 | 2.53 |
| | carboxaldehyde,dimethyl- | | | | |
| 69 | Oxacyclohexadecan-2-one | 106-02-5 | Lactone | 240 | 6.29 |
| 70 | Methy-2-methyl-3-(4-tert | 91-51-0 | Schiffs base | 337 | 6.31 |
| | butylphenyl)propylidenanthranilate | | | | |
| 71 | Acetic acid,(3- | 67634-00-8 | Ester | 186 | 2.38 |
| | methylbutoxy)-,2-propenyl | | | | |
| | ester | | | | |
| 72 | 9-Undecenal,2,6,10- | 141-13-9 | Aldehyde | 210 | 5.16 |
| | trimethyl- | | | | |
| 73 | Cyclopentanone,3-methyl- | 13074-63-0 | Ketone | 168 | 3.46 |
| | 2-pentyl- | | | | |

In another aspect of the invention said perfume composition comprises at least 10%, 20%, 30%, 40%, 50%, 60%, 70%, 80%, or even 90% of a perfume component selected from the group consisting the perfume components 1 through 28 listed in Table 1 above and mixtures thereof.

In any of the aforementioned aspects of said perfume composition, said perfume composition may comprise an ester perfume component having the following formula: 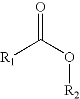
wherein R₁ and R₂ comprise, independently, at least an alpha carbon and may have beta and/or gamma carbons. R₁ and R₂ can, each independently, be any organic moiety having one or more of the following characteristics: branching or pendant rings in at least one of the alpha, beta or gamma positions of R₁ and/or R₂; branching or pendant rings in at least one of the alpha or beta positions of R₁ and/or R₂; or at least one tertiary carbon atom in the alpha position of R₁ and/or R₂. While not being bound by theory, it is believed that the aforementioned perfume ester characteristics result in increased perfume ester stability, and thus perfume composition stability, when said perfume ester in is the presence of an enzyme that can hydrolyze ester bonds, for example, enzymes classed in EC 3.1.1, such as lipases. Such ester perfumes can show a less than 80%, less than 50% and even less than 20% degradation profile when tested in accordance with the method disclosed in Example 8 of the present application.

In any of the aforementioned aspects of the invention, said perfume composition typically contains no more than about 5%, or even none of the perfume components selected from the group consisting of Acetic acid, phenylmethyl ester; Benzene ethanol; Butanoic acid, 2-methyl-, ethyl ester; 4H-Pyran-4-one, 2-ethyl-3-hydroxy-; Benzaldehyde, 4-hydroxy-3-methoxy-; Benzaldehyde, 3-ethoxy-4-hydroxy-; 3-Hexen-1-ol, acetate, (Z)-; Butanoic acid, 2-methyl-, 1-; methylethyl ester; 3-Decanone, 1-hydroxy-; 2-Heptanone; Benzaldehyde; Propanenitrile, 3-(3-hexenyloxy)-, (Z)-; 2-Butanone, 4-phenyl-; 2-Hexen-1-ol; 2(3H)-Furanone, 5-butyldihydro-.

Suitable perfume materials for producing the perfume compositions disclosed herein may be obtained from the following suppliers Argeville Kantcheff GmbH Nerotal 45, D 6200 Wiesbaden, Germany; Biolandes Parfumerie 44 Route de Plascassier BP156-06336 GRASSE CEDEX, France; CAPUA s.r.l. Zona Industriale 89052 Campo Calabro (RC), Italy; CHARABOT 10, Avenue Yves-Emmanuel Baudoin 06130 Grasse, France; Drom International Inc 2776 Camden Court, Lisle Ill. 60532 USA; Fragrance Resources Inc. 275 Clark Street P.O Box 110 Keyport, N.J. 07735 USA; Firmenich S. A. 1, Route Des Jeunes CH-1211, Geneva Switzerland; Firmenich Incorporated PO Box 5880 Princeton, N.J. 08543 USA; Givaudan France S. A. 19-23 Voie des Bans BP 98 95101 Argenteuil Cedex France; Givaudan S. A. Corporate Headquarters BP 985 Chemin de la Parfumerie 1214 Vernier Switzerland; Henkel KgaA CFC Fragrance Division Henkelstrasse 67 D-40191 Dusseldorf Germany; International Flavors & Fragrances IFF Liebergerweg 72-98 PO Box 309 1200 AH Hilversum The Netherlands; IFF (France) 47 Rue Victor-Hugo 92270 Bois-Colombes France; International Flavors & Fragrances IFF Daksa 12580 Benicarlo (Castellon) Spain; International Flavors & Fragrances IFF The Creative Center 650 State HWY, 36 Hazlet, N.J. 07730 USA; Kantcheff GmbH Nerotal 45, D 6200 Wiesbaden Germany; V. Mane Fils SA, France 620 Route de Grasse 06620 Le Bar-sur-Loup France; Mane Ltd Concorde House Balcombe Road Haywards Heath Sussex RH16 1NS; Millenium 141 Rue Saint Lambert, Bte 2 1200 Brussels Belgium; Millennium PO Box 389 Jacksonville, Fla. 32201-0389 USA; Noville 2B Cardigan Road Richmond Surrey TW10 6BJ; Noville 3 Empire Boulevard South Hackensack N.J. 07606-1806 USA; PFW Aroma Chemicals B. V. Nijverheidsweg 60 P.O. Box 414 3770 AK Barneveld The Netherlands; Symrise GmbH Muhlenfeldstrasse D-37603 Holzminden Germany; Quest International P.O. Box 2 Naarden-Bussum The Netherlands; Quest International Fragrance Company 400 International Drive, PO Box 901 Mount Olive, N.J. 07828 USA; Quest International Ashford Kent TN24 0LT England; Rhodia Organique Fine Ltd PO Box 46, St Andrews Road Avonmouth Bristol BS 11 9YF; Soda Aromatic CO., Ltd. Soda Building No 15-9, Nihonbashi Honcho 4-Chrome, Chuo-Ku, Tokyo 103 Japan; Synarome 40 rue Raspail, BP 20 92270 Bois Colombes France; Takasago Int. Corp. 11 Volvo Drive, Rockleigh N.J. 07647-0932 USA; and Takasago Int. (NEDERLAND) B. V. Gooimeer 9 1411 DD Naarden The Netherlands.

Processes of Making Perfume Compositions

Perfume compositions of the present invention may be made by ad-mixing of perfume raw materials, which are typically liquids. Certain perfume raw materials are solid materials and can require gentle heat to homogenise with the rest of the perfume. The perfume blend can also comprise a significant proportion of a diluent (e.g dipropylene glycol), an antioxidant or a solubilising material. Solubilisers can be particularly advantageous where the surfactant level is low in order to disperse the perfume in a predominantly hydrophilic matrix such as aqueous liquid cleaners.

Perfume Delivery Methods

Any of the aforementioned aspects of the perfume compositions may be combined with other materials to produce any of the following delivery systems: starch encapsulate delivery systems, porous carrier material delivery systems, coated porous carrier material delivery systems, microencapsulate delivery systems. Suitable methods of producing the aforementioned delivery systems may be found in one or more of the following U.S. Pat. Nos. 6,458,754; 5,656,584; 6,172,037; 5,955,419 and 5,691,383 and WIPO publications WO 94/28017, WO 98/41607, WO 98/52527. Such delivery systems may be used alone, in combination with each other or even in combination with the neat sprayed on or admixed perfume compositions of the present invention in a consumer product.

Consumer Products

In a first aspect of Applicants' invention, Applicants' invention includes a consumer product comprising at least 0.05 weight percent or even from about 0.05 weight percent to about 30 weight percent of a perfume composition of the present invention, any balance of said compositions being one or more adjunct materials, such consumer product may contain a fatty acid odor or a material that generates a fatty acid odor or combination thereof.

In a second aspect of Applicants' invention, Applicants' invention includes cleaning and/or treatment compositions comprising from about 0.05 to about 5 weight percent, from about 0.05 to about 2 weight percent, from about 0.05 to about 1 weight percent of said perfume composition and a fatty acid odor, material that generates a fatty acid odor such butyric acid, for example a lipase, or combination of a fatty acid odor or a material that generates a fatty acid odor, any balance of said compositions being one or more adjunct materials.

In said first and second aspects of Applicants' invention, said material that generates a fatty acid odor may be selected from the group consisting of enzymes classified as follows: EC number 3.1 (enzymes capable of hydrolyzing ester bonds), EC number 3.1.1 (enzymes that hydrolyse carboxylic ester bonds), EC number 3.1.1.3 (lipases), EC number 3.1.1.50 (wax ester hydrolases) and EC number 3.1.1.74 (cutinases). Examples of EC 3.1.1.3 lipases, include those described in WIPO publications WO 00/60063, WO 99/42566, WO 02/062973, WO 97/04078, WO 97/04079 and U.S. Pat. No. 5,869,438, Examples of lipases include LIPEX®, LIPOLASE ULTRA® and LIPOPRIME® and LIPOLASE® (registered tradenames of Novozymes) and LIPASE P “AMANO®” available from Areario Pharmaceutical Co. Ltd., Nagoya, Japan, AMANO-CES®, commercially available from Toyo Jozo Co., Tagata, Japan; and further Chromobacter viscosum lipases from U.S. Biochemical Corp., U.S.A. and Diosynth Co., Netherlands, and other lipases such as Pseudomonas gladioli. Additional useful lipases are described in WIPO publications WO 2004/101759, WO 2004/101760 and WO 2004/101763.

Adjunct Materials

While not essential for the purposes of the present invention, the non-limiting list of adjuncts illustrated hereinafter are suitable for use in the instant compositions and may be desirably incorporated in certain embodiments of the invention, for example to assist or enhance cleaning performance, for treatment of the substrate to be cleaned, or to modify the aesthetics of the cleaning composition as is the case with colorants, dyes or the like. The precise nature of these additional components, and levels of incorporation thereof, will depend on the physical form of the composition and the nature of the cleaning operation for which it is to be used. Suitable adjunct materials include, but are not limited to, surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, structure elasticizing agents, fabric softeners, carriers, hydrotropes, processing aids, solvents and/or pigments. In addition to the disclosure below, suitable examples of such other adjuncts and levels of use are found in U.S. Pat. Nos. 5,576,282, 6,306,812 B1 and 6,326,348 B 1 that are incorporated by reference.

As stated, the adjunct ingredients are not essential to Applicants' compositions. Thus, certain embodiments of Applicants' compositions do not contain one or more of the following adjuncts materials: surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, structure elasticizing agents, fabric softeners, carriers, hydrotropes, processing aids, solvents and/or pigments. However, when one or more adjuncts are present, such one or more adjuncts may be present as detailed below:

Bleaching Agents—The cleaning compositions of the present invention may comprise one or more bleaching agents. Suitable bleaching agents other than bleaching catalysts include photobleaches, bleach activators, hydrogen peroxide, sources of hydrogen peroxide, pre-formed peracids and mixtures thereof. In general, when a bleaching agent is used, the compositions of the present invention may comprise from about 0.1% to about 50% or even from about 0.1% to about 25% bleaching agent by weight of the subject cleaning composition. Examples of suitable bleaching agents include:

(1) photobleaches for example sulfonated zinc phthalocyanine;

(2) preformed peracids: Suitable preformed peracids include, but are not limited to, compounds selected from the group consisting of percarboxylic acids and salts, percarbonic acids and salts, perimidic acids and salts, peroxymonosulfuric acids and salts, for example, Oxzone®, and mixtures thereof. Suitable percarboxylic acids include hydrophobic and hydrophilic peracids having the formula R—(C═O)O—O-M wherein R is an alkyl group, optionally branched, having, when the peracid is hydrophobic, from 6 to 14 carbon atoms, or from 8 to 12 carbon atoms and, when the peracid is hydrophilic, less than 6 carbon atoms or even less than 4 carbon atoms; and M is a counterion, for example, sodium, potassium or hydrogen;

(3) sources of hydrogen peroxide, for example, inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts are selected from the group consisting of sodium salts of perborate, percarbonate and mixtures thereof. When employed, inorganic perhydrate salts are typically present in amounts of from 0.05 to 40 wt %, or 1 to 30 wt % of the overall composition and are typically incorporated into such compositions as a crystalline solid that may be coated. Suitable coatings include, inorganic salts such as alkali metal silicate, carbonate or borate salts or mixtures thereof, or organic materials such as water-soluble or dispersible polymers, waxes, oils or fatty soaps; and

(4) bleach activators having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof—especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoyloxybenzene sulphonate (NOBS). Suitable bleach activators are also disclosed in WO 98/17767. While any suitable bleach activator may be employed, in one aspect of the invention the subject cleaning composition may comprise NOBS, TAED or mixtures thereof.

When present, the peracid and/or bleach activator is generally present in the composition in an amount of from about 0.1 to about 60 wt %, from about 0.5 to about 40 wt % or even from about 0.6 to about 10 wt % based on the composition. One or more hydrophobic peracids or precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or even 2:1 to 10:1.

Surfactants—The cleaning compositions according to the present invention may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof. When present, surfactant is typically present at a level of from about 0.1% to about 60%, from about 1% to about 50% or even from about 5% to about 40% by weight of the subject composition.

Builders—The cleaning compositions of the present invention may comprise one or more detergent builders or builder systems. When a builder is used, the subject composition will typically comprise at least about 1%, from about 5% to about 60% or even from about 10% to about 40% builder by weight of the subject composition. Builders include, but are not limited to, the alkali metal, ammonium and alkanolammonium salts of polyphosphates, alkali metal silicates, alkaline earth and alkali metal carbonates, aluminosilicate builders and polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

Chelating Agents—The cleaning compositions herein may contain a chelating agent. Suitable chelating agents include copper, iron and/or manganese chelating agents and mixtures thereof. When a chelating agent is used, the subject composition may comprise from about 0.005% to about 15% or even from about 3.0% to about 10% chelating agent by weight of the subject composition.

Dye Transfer Inhibiting Agents—The cleaning compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

Brighteners—The cleaning compositions of the present invention can also contain additional components that may tint articles being cleaned, such as fluorescent brighteners. Suitable fluorescent brightener levels include lower levels of from about 0.01, from about 0.05, from about 0.1 or even from about 0.2 wt % to upper levels of 0.5 or even 0.75 wt %.

Dispersants—The compositions of the present invention can also contain dispersants. Suitable water-soluble organic materials include the homo- or co-polymeric acids or their salts, in which the polycarboxylic acid comprises at least two carboxyl radicals separated from each other by not more than two carbon atoms.

Enzymes—The cleaning compositions can comprise one or more enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in a cleaning composition, the aforementioned enzymes may be present at levels from about 0.00001% to about 2%, from about 0.0001% to about 1% or even from about 0.001% to about 0.5% enzyme protein by weight of the composition.

Enzyme Stabilizers—Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor, such as a boron compound, can be added to further improve stability.

Catalytic Metal Complexes—Applicants' cleaning compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of ligands such as bispidones (WO 05/042532 A1) and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include, for example, manganese, iron and chromium. Suitable MRLs include 5,12-diethyl-1,5,8,12-tetraazabicyclo[6.6.2]hexadecane. Suitable transition metal MRLs are readily prepared by known procedures, such as taught for example in WO 00/32601, and U.S. Pat. No. 6,225,464.

Solvents—Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

Processes of Making Cleaning and/or Treatment Compositions

The cleaning and/or treatment compositions of the present invention can be formulated into any suitable form and prepared by any process chosen by the formulator, non-limiting examples of which are described in Applicants' examples and in U.S. Pat. Nos. 5,879,584; 5,691,297; 5,574,005; 5,569,645; 5,565,422; 5,516,448; 5,489,392; 5,486,303.

Method of Use

The present invention includes a method for cleaning, treating and/or masking the odor of a situs for example, a surface or fabric. Such method includes the steps of optionally washing and or rinsing a situs, then contacting an embodiment of Applicants' perfume composition or consumer product containing such composition, in neat form or diluted in a wash liquor, with at least a portion of the situs then optionally rinsing such situs. The situs may be subjected to a washing step prior to the aforementioned rinsing step. For purposes of the present invention, washing includes but is not limited to, scrubbing, and mechanical agitation. As will be appreciated by one skilled in the art, aspects of the consumer products of the present invention are ideally suited for use in laundry applications. Accordingly, the present invention includes a method for laundering a fabric. The method comprises the steps of contacting a fabric to be laundered with a cleaning laundry solution comprising at least one embodiment of Applicants' cleaning and/or treatment composition, cleaning additive or mixture thereof. The fabric may comprise most any fabric capable of being laundered in normal consumer use conditions. The solution preferably has a pH of from about 8 to about 10.5. The consumer products may be employed at concentrations of from about 500 ppm to about 15,000 ppm in solution. The water temperatures typically range from about 5° C. to about 90° C. The water to fabric ratio is typically from about 1:1 to about 30:1.

Test Methods

1.) cLogP: The cLogP of a perfume component is determined in accordance with the protocol described in U.S. Pat. No. 6,916,769 and when a perfume composition is described and/or recites that at least 80% of said perfume component has a certain cLogP value, it means for example that 8 out of 10 or 4 out of 5 etc. of the recited perfume components have the recited cLogP.

### EXAMPLE 1

### Perfume Compositions According to the Invention

| | | Composition | | | |
|---|---|---|---|---|---|
| Common Name | CAS | 1 | 2 | 3 | 4 |
| Yara Yara | 93-04-9 | 5 | | | |
| Diphenyl Oxide | 101-84-8 | 2 | 7 | | 5 |
| Iso Eugenol | 120-11-6 | | | 6 | |
| Eugenol | 97-53-0 | | | 4 | 5 |
| Dynascone ® | 56973-85-4 | 1 | 1.5 | | |
| Delta damascone | 71048-82-3 | 2 | | 4 | |
| Ionone Gamma | 127-51-5 | | | 20 | 5 |
| Methyl | | | | | |
| Nectaryl | 95962-14-4 | 20 | | | |
| Ionone alpha | 127-41-3 | | | 4 | |
| Dartanol | 28219-61-6 | | | 8 | |
| Levosandol ® | 28219-61-6 | | | 8 | |
| Hedione ® | 24851-98-7 | | 25 | | 40 |
| Dihydro | 37172-53-5 | | 10 | 12 | 5 |
| IsoJasmonate ® | | | | | |
| Frutene | 17511-60-3 | 25 | | | |
| Flor Acetate | 2500-83-6 | 25 | | | |
| Amyl Salicylate | 2050-08-0 | | 20 | | |
| Coumarin | 91-64-5 | | | 4 | |
| Dupical | 30168-23-1 | | 1 | | |
| Florhydral ® | 125109-85-5 | | 2 | | |
| Lilial | 80-54-6 | | 20 | 20 | |
| Hexyl Cinnamic | 101-86-0 | | | | 40 |
| aldehyde | | | | | |
| Aldehyde C10 | 10486-19-8 | 5 | | | |
| Lauric Aldehyde | 112-54-9 | | 1.5 | | |
| Peonile ® | 104621-98-0 | 15 | 12 | | |
| Patchouli | | | | 10 | |
| Balance | | 100 | 100 | 100 | 100 |

### EXAMPLE 2

### Perfumes Made with Compositions According to the Invention

| | | Perfume Example | | | |
|---|---|---|---|---|---|
| Common Name | CAS | A | B | C | D |
| Composition 1 | n/a | 61 | | | |
| Composition 2 | n/a | | 45 | | |
| Composition 3 | n/a | | | 26 | |
| Composition 4 | n/a | | | | 10 |
| Cetalox | 3738-00-9 | | 0.5 | | |
| Delphone | 4819-67-4 | | | | 2 |
| Delta Muscenone | 82356-51-2 | | | 1 | |
| Undecalactone | 104-67-6 | 1 | | | |
| Aldehyde MNA | 110-41-8 | 2 | | | |
| Undecavertol | 81782-77-6 | | 2 | | |
| Cyclohexyl salicylate | 25485-88-5 | | 3 | | |
| Cashmeran ® | 33704-61-9 | | | 1 | |
| Agrumea | 68738-99-8 | | | 3 | |
| Hexyl Acetate | 142-92-7 | 5 | | | |
| Verdox | 88-41-5 | 10 | | | |
| Methyl Cedrylone | 32388-55-9 | | 2 | | |
| Heliotropin | 120-57-0 | | | 1 | |
| Benzyl Salicylate | 118-58-1 | | | 4 | |
| Iso Jasmone | 11050-62-7 | | | | 1 |
| Habanolide ® | 34902-57-3 | | | 5 | 5 |
| Aurantiol | 89-43-0 | | | | 1 |
| Cis-3-hexenyl salicylate | 65405-77-8 | | 3 | | |
| Methyl Anthranilate | 134-20-3 | 1 | | | |
| Hexyl Salicylate | 6259-76-3 | | 4 | | |
| Manzanate | 28959-02-6 | 1 | | | |
| Geranyl Nitrile | 5146-66-7 | 2 | | | |
| Ligustral | 27939-60-2 | 1 | 2 | | |
| Allyl Amyl Glycolate | 67634-00-8 | | 1 | | |
| Adoxal | 141-13-9 | | 0.5 | | |
| Jasmylone | 13074-63-0 | | | | 1 |
| Benzyl Acetate | 140-11-4 | | | 10 | 58 |
| Phenyl Ethyl Alcohol | 60-12-8 | | 34 | | |
| Vanillin | 121-33-5 | | | 1 | |
| Ethyl Vanillin | 121-32-4 | | | 0.5 | |
| Cis 3 hexenyl acetate | 3681-71-8 | | 1 | | |
| Cinnamalva | 1885-38-7 | | | 1 | |
| Benzyl Acetone | 2550-26-7 | | | 20 | 20 |
| Beta Gamma Hexenol | 2305-21-7 | 1 | 2 | | 1 |
| Gamma Octalactone | 104-50-7 | | | 0.5 | 1 |
| D-Limonene | 138-86-3 | 15 | | 26 | |
| Total | | 100 | 100 | 100 | 100 |

In following detergent compositions, enzymes levels are given as percent pure enzyme per 100 grams total composition and the perfume component is a perfume according to the present invention and/or Examples 1 and 2 above. The perfumes used in Examples 3 through 6 are perfume compositions according to the present invention, for example the perfume compositions of Examples 1 and 2. Unless stated otherwise, the balance of the compositions of Examples 3 through 6 are water and minors such as, suds suppressors etc. Abbreviated component identifications for Examples 3 through 6 are as follows:
LAS Sodium linear C₁₁₋₁₃ alkyl benzene sulphonate.
CxyAS Sodium C₁ₓ-C_{1y} alkyl sulfate.
CxyEzS C₁ₓ-C_{1y} sodium alkyl sulfate condensed with an average of z moles of ethylene oxide.
CxEOy Cx alcohol with an average of ethoxylation of y
QAS R₂.N+(CH₃)₂(C₂H₄₀H) with R₂═C₁₀-C₁₂
Soap Sodium linear alkyl carboxylate derived from a 80/20 mixture of tallow and coconut fatty acids.
Silicate Amorphous Sodium Silicate (SiO₂:Na₂O ratio=1.6-3.2: 1).
Zeolite A Hydrated Sodium Aluminosilicate of formula Na₁₂(AlO₂SiO₂)₁₂. 27H₂O having a primary particle size in the range from 0.1 to 10 micrometers (Weight expressed on an anhydrous basis).
(Na—)SKS-6 Crystalline layered silicate of formula δ-Na₂Si₂O₅.
Citrate Tri-sodium citrate dihydrate.
Citric Anhydrous citric acid.
Carbonate Anhydrous sodium carbonate.
Sulphate Anhydrous sodium sulphate.
MA/AA Random copolymer of 4:1 acrylate/maleate, average molecular weight about 70,000-80,000.
AA polymer Sodium polyacrylate polymer of average molecular weight 4,500.
PB1/PB4 Anhydrous sodium perborate monohydrate/tetrahydrate.
PC3 Anhydrous sodium percarbonate [2.74 Na₂CO₃.3H₂O₂]
TAED Tetraacetyl ethylene diamine.
NOBS Nonanoyloxybenzene sulfonate in the form of the sodium salt.
DTPA Diethylene triamine pentaacetic acid.
HEDP Hydroxyethane di phosphonate
HEDMP Hydroxyethane di (methylene) phosphonate
DETPMP Diethyltriamine penta (methylene) phosphonate
EDDS Na salt of Ethylenediamine-N,N′-disuccinic acid, (S,S) isomer
STPP Sodium tripolyphosphate
Protease Proteolytic enzyme sold under the tradename Savinase® Alcalase®, Everlase®, Coronase®, Polarzyme®, by Novozymes A/S, Properase®, Purafect®, Purafect MA® and Purafect Ox® sold by Genencor and proteases described in patents WO 91/06637 and/or WO 95/10591 and/or EP 0 251 446.
Amylase Amylolytic enzyme sold under the tradename Purastar®, Purafect Oxam® sold by Genencor; Termamyl®, Fungamyl® Duramyl®, Stainzyme® and Natalase® sold by Novozymes A/S.
Lipase Lipolytic enzyme sold under the tradename Lipolase®, Lipolase Ultra®, Lipex® by Novozymes A/S.
Cellulase Cellulytic enzyme sold under the tradename Carezyme®, Celluzyme® and/or Endolase® by Novozymes A/S or a Glucanase enzyme
Pectate Lyase Pectawash®, Pectaway® sold by Novozymes
Mannanase Mannaway® sold by Novozymes
CMC or HEC Carboxymethyl or Hydroxyethyl or ester modified cellulose.
or EMC
SS Agglom. 12% Silicone/silica, 18% stearyl alcohol,70% starch in granular form [suds suppressor agglomerate].
TEPAE Tetreaethylenepentaamine ethoxylate.
Photobleach Sulfonated zinc phtalocyanine
pH Measured as a 1% solution in distilled water at 20° C.

### EXAMPLE 3

### Bleaching High Duty Laundry Detergent Compositions are Prepared

| | I | II | III | IV | V | VI | VII | VIII |
|---|---|---|---|---|---|---|---|---|
| Blown Powder | | | | | | | | |
| Zeolite A | 13.65 | 13.65 | — | — | — | — | — | — |
| Na Sulfate | 22.67 | 22.67 | 24.43 | 30.13 | — | — | — | — |
| LAS | 6.21 | 6.21 | 5.65 | — | — | — | — | — |
| QAS | — | — | — | 2.95 | — | — | — | — |
| MA/AA | 1.42 | 1.42 | 3.50 | 4.25 | — | — | — | — |
| EDDS | 0.19 | 0.19 | 0.19 | 0.23 | — | — | — | — |
| Brightener | 0.07 | 0.07 | 0.06 | 0.08 | — | — | — | — |
| Mg Sulfate | 0.65 | 0.65 | 0.39 | 0.48 | — | — | — | — |
| HEDMP | 0.17 | 0.17 | 0.17 | 0.21 | — | — | — | — |
| Agglomerate 1 | | | | | | | | |
| QAS | — | — | 0.9 | — | — | — | — | — |
| Carbonate | — | — | 2.45 | — | — | — | — | — |
| Na Sulfate | — | — | 2.45 | — | — | — | — | — |
| Agglomerate 2 | | | | | | | | |
| C₁₄₋₁₅EO₇ | — | — | 2.79 | 2.21 | — | — | — | — |
| Na Sulfate | — | — | 6.65 | 6.84 | — | — | — | — |
| Agglomerate 3 | | | | | | | | |
| LAS | — | — | — | — | 13.63 | 14.96 | — | 13.63 |
| Zeolite A | — | — | — | — | 21.42 | 23.51 | — | 21.42 |
| Agglomerate 4 | | | | | | | | |
| LAS | — | — | — | — | — | — | 8.12 | — |
| Na Sulfate | — | — | — | — | — | — | 23.54 | — |
| Na Carbonate | — | — | — | — | — | — | 8.12 | — |
| Dry additives | | | | | | | | |
| LAS | — | — | 6.40 | — | — | — | — | — |
| MA/AA | — | — | 0.89 | 0.89 | 0.95 | 0.95 | 0.99 | 0.95 |
| (particle) | | | | | | | | |
| TAED | 3.58 | 3.58 | 3.80 | 2.70 | 5.89 | 5.89 | 6.14 | — |
| NOBS | — | — | — | — | — | — | — | 5.50 |
| LAS (flakes) | — | — | — | 27.0 | — | — | — | — |
| Silicate R 2.0 | 3.85 | 3.85 | 3.85 | 2.80 | — | — | — | — |
| Citric/Citrate | 3.58 | 3.58 | 3.58 | 3.58 | 3.80 | 3.80 | 3.96 | 3.80 |
| Na Carbonate | 7.72 | 7.72 | 13.84 | — | 12.35 | — | 12.87 | 12.35 |
| HEDP | — | — | — | — | 0.48 | 0.48 | 0.50 | 0.48 |
| PC3 or PB1 | 11.01 | 11.01 | 11.01 | 8.00 | 8.55 | 8.55 | 8.91 | 8.55 |
| Protease | 0.009 | 0.009 | 0.009 | 0.009 | 0.039 | 0.039 | 0.039 | 0.039 |
| Amylase | 0.005 | 0.005 | 0.005 | 0.005 | 0.013 | 0.013 | 0.013 | 0.013 |
| Lipase | — | — | 0.001 | — | 0.002 | 0.002 | 0.002 | 0.002 |
| Pectate lyase | — | — | — | — | 0.003 | 0.003 | 0.003 | 0.003 |
| Cellulase | 0.003 | — | 0.001 | — | 0.0005 | — | — | — |
| SS agglom. | 0.36 | 0.36 | 0.36 | 0.55 | 0.62 | 0.62 | 0.64 | 0.62 |
| Soap | 0.40 | 0.40 | 0.40 | 0.40 | 0.48 | 0.48 | 0.50 | 0.48 |
| Brightener | — | — | — | — | 0.10 | 0.10 | 0.10 | 0.10 |
| Perfume | 0.5 | 0.4 | 0.2 | 0.7 | 0.4 | 0.5 | 0.4 | 0.6 |
| Na Sulfate | 4.48 | 4.48 | — | — | 14.30 | 22.85 | 14.90 | 14.30 |
| Spray on | | | | | | | | |
| C₁₂₋₁₄EO₇ | 4.00 | 4.00 | — | — | 3.00 | 3.00 | 1.00 | 3.00 |
| Dusting | | | | | | | | |
| Zeolite A | — | — | — | — | 2.00 | 2.00 | — | 2.00 |
| Density (g/L) | 600 | 600 | 600 | 600 | 800 | 800 | 800 | 800 |

### EXAMPLE 4

### Laundry Granules and Tablets Having the Following Formula are Prepared

| Base Product | I | II | III | IV | V |
|---|---|---|---|---|---|
| C₁₄-C₁₅ AS/Tallow AS | 8.0 | 5.0 | 3.0 | 3.0 | 3.0 |
| LAS | 8.0 | — | 8.0 | — | 7.0 |
| C₁₂C₁₅AE₃S | 0.5 | 2.0 | 1.0 | — | — |
| C₁₂C₁₅AE₅/AE₃ | 2.0 | — | 5.0 | 2.0 | 2.0 |
| QAS | — | — | — | 1.0 | 1.0 |
| Zeolite A | 20.0 | 18.0 | 11.0 | — | 10.0 |
| (Na—)SKS-6 (I) | — | — | 9.0 | — | — |
| (dry add) | | | | | |
| MA/AA | 2.0 | 2.0 | 2.0 | — | — |
| AA polymer | — | — | — | — | 4.0 |
| Citrate | — | 2.0 | — | — | — |
| Citric | 2.0 | — | 1.5 | 2.0 | — |
| DTPA | 0.2 | 0.2 | — | — | — |
| EDDS | — | — | 0.5 | 0.1 | — |
| HEDP | — | — | 0.2 | 0.1 | — |
| PB1 | 3.0 | 5.0 | 10.0 | — | 4.0 |
| Percarbonate | — | — | — | 18.0 | — |
| NOBS | 3.0 | 4.0 | — | — | 4.0 |
| TAED | — | — | 2.0 | 5.0 | — |
| Carbonate | 15.0 | 18.0 | 8.0 | 15.0 | 15.0 |
| Sulphate | 5.0 | 12.0 | 2.0 | 17.0 | 3.0 |
| Perfume | 0.8 | 0.6 | 0.4 | 0.5 | 0.3 |
| Silicate | — | 1.0 | — | — | 8.0 |
| Protease | 0.033 | 0.033 | 0.033 | 0.046 | 0.033 |
| Lipase | 0.003 | 0.002 | 0.005 | 0.008 | 0.006 |
| Amylase | 0.001 | 0.001 | 0.001 | 0.0014 | 0.001 |
| Cellulase | 0.0014 | 0.0014 | 0.0014 | 0.01 | — |

### EXAMPLE 5

### The Following Granular Detergents are Prepared

| | I | II | III | IV | V | VI | VII |
|---|---|---|---|---|---|---|---|
| LAS | 7.23 | 8.46 | 6.50 | 7.09 | 11.13 | 16.0 | 16.0 |
| QAS | 0.75 | — | 0.60 | 0.60 | 1.00 | — | — |
| C₁₄₋₁₅EO₇ | 3.50 | 5.17 | 3.50 | 3.70 | 3.50 | — | — |
| C₁₂₋₁₄AE₃S | 0.25 | — | — | — | — | 0.70 | 1.0 |
| C₁₂₋₁₄—N⁺(CH₃)₂(C₂H₄OH) | — | — | — | — | — | 0.50 | 0.50 |
| Na tripolyphosphate | 18.62 | 25.00 | 18.62 | 24.00 | 45.00 | 15.0 | 18.0 |
| Zeolite A | — | — | 0.79 | — | — | 0.18 | 0.3 |
| Citric acid | 1.29 | — | 1.29 | — | — | — | — |
| Sodium Silicate | 3.10 | 8.00 | 4.26 | 3.87 | 10.00 | 8.0 | 6.0 |
| Sodium Carbonate | 18.04 | 11.00 | 18.04 | 18.98 | 0.42 | 14..5 | 16.0 |
| Sulfate | 17.58 | 3.98 | 19.93 | 15.48 | 10.13 | 30.0 | 30.0 |
| CMC | — | — | — | — | — | 0.20 | 0.20 |
| AA/MA | 2.15 | 1.50 | 1.85 | 1.60 | 1.94 | 0.1 | 0.05 |
| AA polymer | — | — | — | — | — | — | 1.20 |
| Amine ethoxylate polymer | 0.60 | — | 0.49 | — | — | — | 1.25 |
| Cyclic polyamine polymer | 0.07 | — | 0.07 | — | — | — | — |
| Percarbonate | 13.15 | — | 10.77 | — | — | — | — |
| PB1/PB4 | — | 9.0/9.0 | — | 10.45/0 | 2.37/0 | — | — |
| TAED | 2.50 | 5.00 | 1.58 | 1.52 | 0.66 | — | — |
| DTPA | 0.34 | 0.34 | 0.37 | 0.39 | 0.24 | 0.30 | 0.30 |
| Mg Sulfate | 1.37 | 1.43 | 1.37 | 1.41 | 0.58 | — | — |
| Protease | 0.005 | 0.011 | 0.006 | — | — | 0.006 | 0.003 |
| Amylase | 0.001 | 0.003 | 0.001 | 0.001 | — | — | 0.001 |
| Cellulase | 0.0003 | 0.0002 | 0.0003 | 0.0003 | — | — | — |
| Brightener | 0.10 | 0.17 | 0.08 | 0.08 | 0.08 | 0.23 | 0.15 |
| Lipase | 0.002 | 0.002 | 0.004 | 0.01 | 0.006 | 0.004 | 0.003 |
| Perfume | 0.4 | 0.6 | 0.5 | 0.7 | 0.6 | 0.4 | 0.3 |

### EXAMPLE 6

### The Following Liquid Detergent Formulations are Prepared

| | I | II | III | IV | V | VI |
|---|---|---|---|---|---|---|
| LAS | 7.8 | 12.2 | 4.4 | 12.2 | 5.7 | 1.3 |
| Sodium alkyl ether | — | — | 14.4 | — | 9.2 | 5.4 |
| sulfate | | | | | | |
| Alkyl ethoxylate | 5.7 | 8.8 | 2.2 | 8.8 | 8.1 | 3.4 |
| Amineoxide | 1.0 | 1.5 | 0.7 | 1.5 | — | — |
| Fatty acid | 5.3 | 8.3 | 3.0 | 8.3 | — | — |
| Citric acid (50%) | 1.1 | 6.8 | 2.0 | 3.4 | 1.9 | 1.0 |
| Ca and Na formate | — | — | 0.2 | — | — | — |
| Na cumene | 0.8 | 2 | — | 2.0 | — | — |
| sulphonate | | | | | | |
| Borate | — | — | 1.5 | 2.4 | 2.9 | — |
| MEA borate | 1.5 | 2.4 | — | — | — | — |
| Na hydroxide | 3.2 | 3.2 | 3.0 | 4.9 | 1.9 | 1.0 |
| Ethanol | 1.4 | 1.4 | 2.5 | 1.4 | 1.5 | — |
| 1,2 Propanediol | 4.9 | 5.0 | 6.6 | 4.9 | 4.0 | — |
| Sorbitol | — | — | — | — | 4.0 | — |
| Ethanolamine | 0.5 | 0.8 | 1.5 | 0.8 | 0.1 | — |
| TEPAE | 0.4 | 0.4 | | | | |
| Protease | 0.02 | 0.028 | 0.04 | 0.028 | 0.04 | — |
| Lipase | — | 0.001 | — | 0.004 | 0.002 | — |
| Amylase | 0.001 | 0.002 | 0.0002 | 0.01 | — | — |
| PVNO | — | — | | | | |
| Brightener | 0.1 | 0.14 | 0.15 | 0.2 | 0.12 | 0.12 |
| Silicone antifoam | — | — | — | 0.05 | — | — |
| Mannanase | 0.0004 | 0.0006 | — | — | — | — |
| Cellulase | 0.0003 | 0.0002 | 0.0003 | — | — | — |
| Amine ethoxylate | 0.8 | 1.3 | 1.8 | 2.1 | — | — |
| polymer | | | | | | |
| AA or MA/AA | — | — | — | — | 0.6 | 0.2 |
| DTPMP, DTPA, | 0.3 | 0.3 | 0.1 | — | — | 0.1 |
| EDTA mixture | | | | | | |
| Perfume | 0.7 | 0.4 | 0.2 | 0.3 | 0.5 | 0.6 |

### EXAMPLE # 7

### The Compositions of Examples 3-6 are Used as Follows

Each composition is combined with separate aliquots of solvent to result in separate solutions comprising from about 500 ppm to about 15,000 ppm of the respective composition. Articles, including garments or hard surfaces, are contacted with the respective solution. When the article is a garment, the solvent to fabric mass ratio is from about 1:1 to about 100:1 and the solution temperature is from about 5° C. to about 90° C. Then the article is optionally washed and/or rinsed. The resulting articles' odor, appearance and/or color is improved and/or maintained.

### EXAMPLE # 8

Perfume ester stability is assayed in the following manner. Blends of perfume esters disclosed in the present application are made by ad-mixing perfume ester raw materials that are disclosed in the present application in equal weight percents. The resultant perfume is added at a 0.3% level to a liquid detergent, sold under the trade name TIDE®. Ester degradation is monitored at time 0 and 24 hours after storage at 20-25° C., both in-product and in a wash solution made by adding 1.5 g of the above liquid detergent to 1 liter of water. The ester content of the resultant liquids and solutions is assayed via standard headspace gas chromatographic methods as described for example in Janusz Pawliszyn “Application of Solid Phase Microextraction”, RS.C, Chapter 26, pages 349-457, 1999. Specifically headspace solid phase microextraction (SPME) is followed by thermal desorption GC/MS analysis. The SPME fiber is coated with 100% polydiemthyl siloxane (PDMS). The thickness of the polymer film on the fiber is 100-um. Samples are put into 20-mL headspace vials with septum seal, and equilibrated for 60 minutes before analysis. For sampling the fiber is placed in the headspace of the sample vial and absoption is carried out for 20 minutes. Then the samples are injected to the GC column under 240° C. for 5 minutes in the injector. GC/MS system used for this work is a 5973 MS couple with 6890 GC, both from Agilent technologies. Separation of the PRM components is accomplished using a 60-m×250-um i.d. capillary column coated with 1-um PDMS phase. The perfume esters show a less than 80%, less than 50% and even less than 20% degradation profile.

What is claimed is:

1. A perfume composition comprising at least 10% of one or more perfume components having a molecular weight of greater than 0 but less than or equal to 350 daltons, at least 80% of said one or more perfume components having a cLogP of at least 2.4, said perfume composition comprising at least 5% of said one or more perfume components having a cLogP of at least 2.4.

2. A perfume composition according to claim 1 said perfume composition comprising at least 20% of said one or more perfume components and;
a.) wherein said one or more perfume components are selected from the group consisting of ethers, phenols, ketones, alcohols, esters, lactones, aldehydes, nitriles, natural oils, Schiff bases or mixtures thereof;
b.) said one or more perfume components having a molecular weight of from about 100 daltons to about 350 daltons; and
b.) at least 80% of said one or more perfume components having a cLogP of from about 2.75 to about 8.0, said perfume composition comprising at least 5% of said one or more perfume components having a cLogP of from about 2.75 to about 8.0.

3. A perfume composition according to claim 2, said perfume composition comprising at least 30% of said one or more perfume components;
a.) said one or more perfume components having a molecular weight of from about 130 daltons to about 270 daltons; and
b.) at least 80% of said one or more perfume components having a cLogP of from about 2.9 to about 6.0, said perfume composition comprising at least 5% of said one or more perfume components having a cLogP of from about 2.9 to about 6.0.

4. A perfume composition according to claim 3 said one or more perfume components have a molecular weight of from about 140 daltons to about 230 daltons.

5. A perfume composition according to claim 1 wherein said one or more perfume component comprises an ester perfume component, said ester perfume component having the formula: 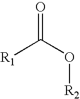
wherein R₁ and R₂ comprise, independently, alpha, beta and/or gamma carbons, said R₁ and R₂ each independently, being an organic moiety having branching or pendant rings in at least one of the alpha, beta or gamma positions of R₁ and/or R₂.

6. A perfume composition according to claim 5, said ester perfume component having branching or pendant rings in at least one of the alpha or beta positions of R₁ and/or R₂.

7. A perfume composition according to claim 6, said ester perfume component having at least one tertiary carbon atom in the alpha position of R₁ and/or R₂.

8. A perfume composition comprising at least 10% of a perfume component selected from the group consisting of Table 1 Perfume Components or mixtures thereof.

9. A perfume composition according to claim 8 wherein said perfume component is selected from the group consisting of Table 1 Perfume Components 1 through 28, and mixtures thereof.

10. A consumer product comprising the perfume composition of claim 1.

11. The consumer product of claim 10, said consumer product comprising an enzyme classified within EC number 3.1 and an adjunct cleaning or treatment composition ingredient.

12. The cleaning or treatment composition of claim 11, said composition comprising a material that generates a fatty acid odor and/or a fatty acid odor.

13. The consumer product of claim 10, said consumer product comprising an enzyme classified within EC number 3.1.

14. A method of cleaning, treating and/or masking the odor of a situs, said method comprising optionally washing and/or rinsing said situs, contacting said situs with a composition according to claim 10, and then optionally washing and/or rinsing said situs.

15. A consumer product comprising the perfume composition of claim 8.

16. The consumer product of claim 15, said consumer product comprising an enzyme classified within EC number 3.1. and an adjunct cleaning or treatment composition ingredient.

17. The cleaning or treatment composition of claim 11, said composition comprising a material that generates a fatty acid odor and/or a fatty acid odor.

18. A method of cleaning, treating and/or masking the odor of a situs, said method comprising optionally washing and/or rinsing said situs, contacting said situs with a composition according to claim 15, and then optionally washing and/or rinsing said situs.

19. A delivery system comprising the perfume composition of claim 1, said delivery system being selected from starch encapsulate delivery systems, porous carrier material delivery systems, coated porous carrier material delivery systems, microencapsulate delivery systems and mixtures thereof.
